(19) United States
(12) Patent Application Publication
(10) Pub. No.: US 2024/0050996 A1
(43) Pub. Date: Feb. 15, 2024

(54) AIR KNIFE AND CLEANING APPARATUS

(71) Applicant: CHANGXIN MEMORY TECHNOLOGIES, INC., Hefei City, Anhui (CN)

(72) Inventor: Qinhao XIAO, Hefei City, Anhui (CN)

(73) Assignee: CHANGXIN MEMORY TECHNOLOGIES, INC., Hefei City, Anhui (CN)

(21) Appl. No.: 17/602,992

(22) PCT Filed: Jul. 12, 2021
(86) PCT No.: PCT/CN2021/105746

§ 371 Date: Jan. 12, 2023

(30) Foreign Application Priority Data
Jul. 5, 2021 (CN) 202110758062.9

(51) Int. Cl. B08B 5/02

(52) U.S. Cl. CPC B08B 5/02

(57) ABSTRACT

An air knife includes a body structure, at least one through hole is provided in the body structure and serves as an airflow channel, an air inlet end of the airflow channel is in communication with an air supply device, and an airflow direction of an air outlet end of the airflow channel has a preset angle relative to an object to be cleaned.

### CROSS-REFERENCE TO RELATED APPLICATIONS

The present application claims priority to Chinese Patent Application No. 202110758062.9, entitled “Air Knife and Cleaning Apparatus”, filed on Jul. 5, 2021, which is incorporated herein by reference in its entirety.

### TECHNICAL FIELD

The present disclosure relates to but is not limited to an air knife and a cleaning apparatus.

### BACKGROUND

As the semiconductor manufacturing technology keeps upgrading, the cost of the mask is increasingly higher, so a pellicle for preventing particles or volatile gas from staining the surface of the mask is required to cover the mask, which guarantees the mask cleanliness. A mask without the pellicle is prone to be stained with the particles and generates a distorted image on the wafer, which influences the quality of the wafer.

With the pellicle covering the mask, the particles will fall onto the pellicle, thereby reducing the influence on the pattern of the mask. The surface of the pellicle needs cleaning in the later period so to keep the pellicle clean.

In the related technology, a needle type air knife is used for cleaning the pellicle. The needle type air knife consists of a plurality of needle tubes, and since the needle tubes are prone to inclination due to external force, the angles of the needle tubes are inconsistent. In a working state, the inclined needle tubes stress the surface of the pellicle unevenly, causing damage of the pellicle and increasing the loss cost.

### SUMMARY

The following is a summary of a subject that is described in detail herein. This summary is not intended to limit the scope of protection of the claims.

A first aspect of the present disclosure provides an air knife. The air knife includes a body structure, at least one through hole is provided in the body structure and serves as an airflow channel, an air inlet end of the airflow channel is in communication with an air supply device, and an airflow direction of an air outlet end of the airflow channel has a preset angle relative to an object to be cleaned.

A second aspect of the present disclosure provides a cleaning apparatus. The cleaning apparatus includes the above air knife and an object to be cleaned, airflow in the air knife flows from an air outlet end of the air knife to a surface of the object to be cleaned.

In the air knife and the cleaning apparatus provided in the embodiments of the present disclosure, the through hole in the body structure servers as the airflow channel, and the airflow channel is of an embedded structure, such that the airflow direction of the air outlet end of the airflow channel constantly has a preset angle relative to the object to be cleaned, and damage to the object to be cleaned due to non-uniform stress may be avoided, thereby improving use safety. When airflow flows to the object to be cleaned, particles and other pollutants on the surface of the object to be cleaned move under the influence of the airflow, so as to achieve a cleaning effect.

Other aspects may be apparent upon reading and understanding the accompanying drawings and detailed description.

### BRIEF DESCRIPTION OF THE DRAWINGS

The accompanying drawings, which are incorporated in and constitute a part of this specification, illustrate embodiments consistent with the present invention and, together with the description, serve to explain the principles of the present invention.

FIG. 1 is a schematic structural diagram of a cleaning apparatus shown in one illustrative embodiment.

FIG. 2 is a schematic diagram of a longitudinal section of the cleaning apparatus shown in the illustrative embodiment in FIG. 1.

FIG. 3 is a schematic diagram of a longitudinal section of a body structure shown in one illustrative embodiment of the present disclosure.

FIG. 4 is a schematic structural diagram of a cleaning apparatus shown in one illustrative embodiment of the present disclosure.

FIG. 5 is a schematic diagram of a longitudinal section of the cleaning apparatus shown in the illustrative embodiment in FIG. 4.

### REFERENCE NUMBERS

1. body structure;
11. through hole; 111. first channel section; 1111. air inlet end; 112. second channel section; 1121. air outlet end;
12. connection branch pipe; 13. connection main pipe;
14. first face; 15. second face;
2. air supply device;
3. object to be cleaned; 31. mask; 32. film;
4. airflow adjustment unit;
5. mounting portion;
51. mounting body; 511. air chamber; 512. opening; and 52. air inlet pipeline.

### DETAILED DESCRIPTION

For making the objectives, technical solutions and advantages of embodiments of the present disclosure more obvious, the technical solutions of the present disclosure will be clearly and completely described below in conjunction with the accompanying drawings in the embodiments of the present disclosure, and obviously, the described embodiments are some, rather than all of the embodiments of the present disclosure. Based on the embodiments of the present disclosure, all other embodiments acquired by those skilled in the art without making creative efforts fall within the scope of protection of the present disclosure. It should be noted that the embodiments of the present disclosure and the features of the embodiments may be combined with each other without conflict.

An illustrative embodiment of the present disclosure provides an air knife. The air knife includes a body structure, wherein at least one through hole is provided in the body structure and serves as an airflow channel, an air inlet end of the airflow channel is in communication with an air supply device, and an airflow direction of an air outlet end of the airflow channel has a preset angle relative to an object to be cleaned. In the present disclosure, the through hole in the body structure servers as the airflow channel, and the airflow channel is of an embedded structure, such that the airflow direction of the air outlet end of the airflow channel constantly has a preset angle relative to the object to be cleaned, and damage to the object to be cleaned due to non-uniform stress may be avoided, thereby improving use safety. When airflow flows to the object to be cleaned, particles and other pollutants on the surface of the object to be cleaned move under the influence of the airflow, so as to achieve a cleaning effect.

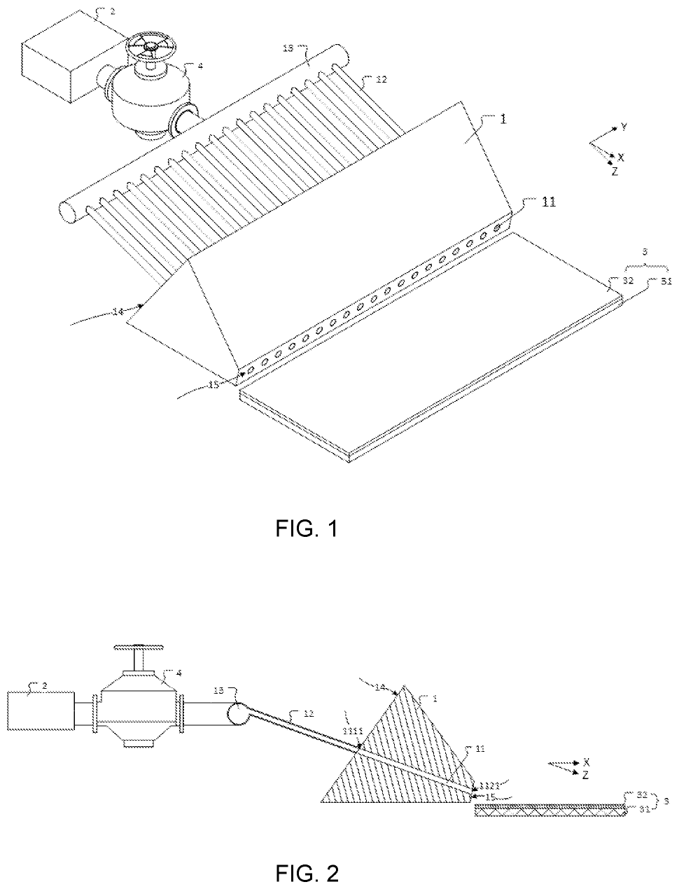

As shown in FIGS. 1 and 2, the air knife includes a body structure 1, where the body structure 1 is made of stainless steel, so as to have high strength and corrosion resistance, thereby prolonging the service life of the air knife.

A through hole 11 is provided in the body structure 1 and serves as an airflow channel for conveying airflow. The air inlet end 1111 of the airflow channel is in communication with the air supply device 2, the air supply device 2 inputs airflow into the airflow channel by means of the air inlet end 1111 of the airflow channel, and the airflow flows in the airflow channel and is output by means of the air outlet end 1121 of the airflow channel. The airflow is conveyed to the object 3 to be cleaned by means of the airflow channel, so as to blow away particles and other pollutants on the surface of the object 3 to be cleaned, thereby achieving the cleaning effect.

The air inlet end 1111 of the airflow channel may be in communication with the air supply device 2 by means of a connection branch pipe 12, and the connection branch pipe 12 is fixedly connected to the body structure 1. A plane in which the connection branch pipe 12 is connected to the body structure 1 is a first face 14 of the body structure 1, an orthographic projection area of the connection branch pipe 12 on the first face 14 of the body structure 1 is greater than an orthographic projection area of the through hole 11 on the first face 14 of the body structure 1, and it is guaranteed that the connection branch pipe 12 may cover the air inlet end 1111 of the airflow channel, such that air leakage is avoided.

A direction (with reference to a Z-axis direction shown in FIGS. 1 and 2) of the airflow output by the air outlet end 1121 of the airflow channel has a preset angle relative to the object 3 to be cleaned, such that the surface of the object 3 to be cleaned is stressed uniformly and controllably, thereby protecting the object 3 to be cleaned and reducing a production loss rate. The preset angle may be 15°-25°, the airflow direction is inclined relative to the object 3 to be cleaned, accordingly, a blowing force of the airflow is moderate, safety during a cleaning process of the object 3 to be cleaned is improved, the phenomenon that the object 3 to be cleaned is damaged is avoided, and particles and other pollutants on the surface of the object 3 to be cleaned are blown off, so as to guarantee the cleanliness of the object 3 to be cleaned.

It should be noted that the number of the through hole 11 provided in the body structure 1 is not limited to one, and may be two or more. At least one through hole 11 may be provided in the body structure 1, and the number of the through hole 11 is influenced by a size of the object 3 to be cleaned. For improving the cleaning effect, it is guaranteed that the surface of the object 3 to be cleaned may be blown, and the plurality of through holes 11 may be provided.

Illustratively, as shown in FIGS. 1 and 2, the air knife includes a body structure 1, a plurality of through holes 11 are provided in the body structure 1, such that the body structure 1 includes a plurality of airflow channels, the plurality of airflow channels are sequentially distributed at intervals in a first direction (with reference to a Y-axis direction shown in FIG. 1) of an object 3 to be cleaned, and accordingly, the airflow channels correspond to different positions of the object 3 to be cleaned. When the air knife is in a working state, airflow of an air outlet end 1121 of the airflow channel may cover a surface of the whole object 3 to be cleaned, such that a cleaning blind area is avoided, and the cleaning effect is further improved.

The plurality of airflow channels are located in the same plane, the plurality of airflow channels are located in a first plane, the object 3 to be cleaned is located in a second plane, and the first plane in which the plurality of airflow channels are located is inclined relative to the second plane in which the object 3 to be cleaned is located, such that the first plane has a preset angle (an included angle between the axis Z and the axis X shown in FIGS. 1 and 2) relative to the second plane. The preset angle may be 15°-25° to guarantee an airflow pressure of the air outlet end 1121 of the airflow channel. When the air knife is in a working state, the air outlet ends 1121 of the plurality of airflow channels output airflow simultaneously, and the airflow may take particles and other pollutants away from the surface of the object 3 to be cleaned, so as to guarantee the cleanliness of the object 3 to be cleaned. The first plane is parallel to the airflow direction (with reference to the Z-axis direction shown in FIG. 1), and the second plane is parallel to the surface of the object 3 to be cleaned.

The air inlet end 1111 of each of the airflow channels is in communication with the air supply device 2, such that the airflow is conveyed in each of the airflow channels, and the airflow flows out of the air outlet ends 1121 of the air flow channels to clean the object 3 to be cleaned. For connecting each through hole 11 to the air supply device 2, each through hole 11 is connected to a connection branch pipe 12, and each connection branch pipe 12 is connected to a connection main pipe 13 and then connected to the air supply device 2 by means of the connection main pipe 13, so as to convey the airflow.

Illustratively, as shown in FIGS. 1 and 2, the airflow channel provided in the present disclosure is of a cylindrical structure and has a preset inner diameter, the preset inner diameter being 0.75 mm-1.25 mm. The airflow channel centralizes the airflow, and a working air pressure in the airflow channel is controlled, so as to guarantee normal work of the air knife. Meanwhile, the airflow channel with the preset inner diameter may improve a blowing force of the airflow, and it is guaranteed that when the airflow reaches the surface of the object 3 to be cleaned, particles and other pollutants may be taken away, so as to achieve the blowing effect.

For guaranteeing the normal work of the air knife, the airflow channel has a preset air pressure, the preset air pressure being greater than 0.3 Mpa. Only the airflow channel has enough pressure, the strength of the airflow output by the air outlet end 1121 of the airflow channel is large enough, and then particles and other pollutants on the surface of the object 3 to be cleaned are taken away, so as to achieve the blowing effect.

It should be noted that the airflow channel is not limited to the above cylindrical structure, and may also have a square column structure, etc. The specific form of the airflow channel may be adjusted according to actual needs.

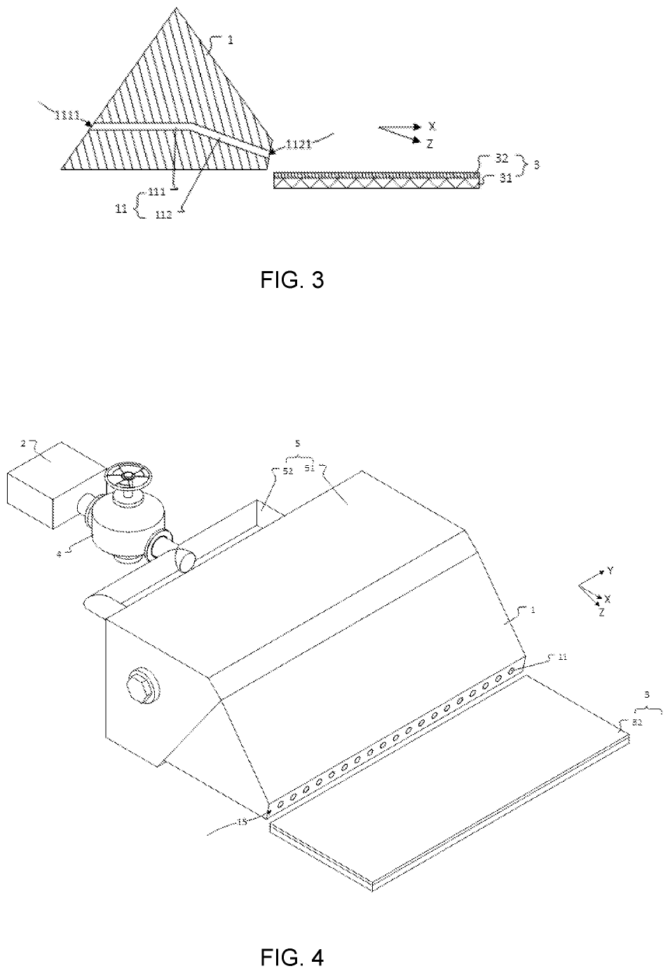

Illustratively, as shown in FIGS. 1 and 3, an air knife includes a body structure 1, a through hole 11 is provided in the body structure 1 and serves as an airflow channel for conveying airflow. The air inlet end 1111 of the airflow channel is in communication with the air supply device 2, the air supply device 2 inputs airflow into the airflow channel by means of the air inlet end 1111 of the airflow channel, and the airflow flows in the airflow channel and is output by means of the air outlet end 1121 of the airflow channel.

The airflow channel provided in the present disclosure may include a first channel section 111 and a second channel section 112, where the first channel section 111 may be a straight section extending in a first direction (with reference to the axis X as shown in FIG. 3) of the object 3 to be cleaned and parallel to the plane of the object 3 to be cleaned. One end of the first channel section 111 serves as an air inlet end 1111 of the airflow channel for inputting airflow. The other end of the first channel section 111 is in communication with one end of the second channel section 112, the second channel section 112 is an inclined section, and the second channel section 112 is inclined relative to the first channel section 111, such that an included angle between the first channel section 111 and the second channel section 112 is a preset included angle, and the preset included angle may be 155°-165°. The other end of the second channel section 112 serves as an air outlet end 1121 of the airflow channel for outputting the airflow.

The airflow enters the first channel section 111 by means of the air inlet end 1111 of the airflow channel and enters the second channel section 112 from the first channel section 111. After flowing through the straight section, the flowing airflow flows to the inclined section, the airflow is buffered since an inner wall of the inclined section may intercept the airflow, the situation that the airflow at the air outlet end 1121 of the airflow channel has an excessively impulsive force is avoided, so as to guarantee that the airflow conveyed to the object 3 to be cleaned may not damage the object 3 to be cleaned.

Illustratively, as shown in FIG. 1, an air knife includes a body structure 1, a through hole 11 is provided in the body structure 1 and serves as an airflow channel for conveying airflow. The air inlet end 1111 of the airflow channel is in communication with the air supply device 2, and specific arrangement and a specific structure of the airflow channel have been described in detail in the above embodiments and are not repeated here.

The air knife provided in the present disclosure further includes an airflow adjustment unit 4, the airflow adjustment unit 4 being connected to the air supply device 2, so as to adjust an airflow parameter in the airflow channel.

Further, the airflow adjustment unit 4 includes a mass flow controller (MFC), where the mass flow controller may include a circuit board, a sensor, a housing, a regulating valve and other components, and a specific structure of the mass flow controller is not specifically stated herein.

The airflow parameters include, but are not limited to, a flow velocity of airflow in the airflow channel, flow of the airflow in the airflow channel, a working air pressure when the airflow in the airflow channel flows, mass of the airflow in the airflow channel, etc.

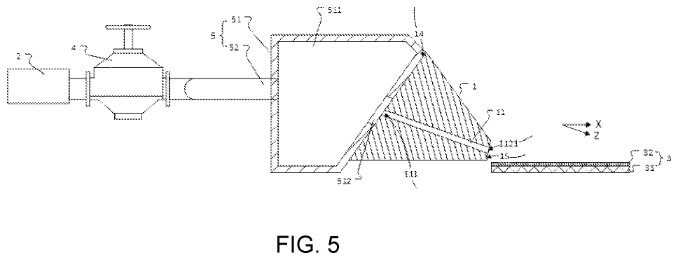

Illustratively, as shown in FIGS. 4 and 5, an air knife includes a body structure 1 and a mounting portion 5, where the body structure 1 is mounted on the mounting portion 5, and the body structure 1 and the mounting portion 5 may be integral. The mounting portion 5 is made of stainless steel, so as to improve rigidity of the mounting portion 5 and prolong service life of the mounting portion 5. The mounting portion 5 is connected to an air supply device 2, and the body structure 1 is connected to the air supply device 2 by means of the mounting portion 5.

A plurality of through holes 11 are provided in the body structure 1 and serve as an airflow channel for conveying airflow. An air chamber 511 is provided in the mounting portion 5, an air inlet end 1111 of each airflow channel is in communication with the air chamber 511, and the air chamber 511 is in communication with the air supply device 2, such that all the airflow channels may be in communication with the air supply device 2 by means of the air chamber 511. The air supply device 2 inputs airflow into the air chamber 511, and when the air chamber 511 is full of the airflow, the airflow enters different airflow channels from the air chamber 511 to achieve airflow conveying.

The airflow output by the air supply device 2 is transferred by the air chamber 511, and when the airflow enters the air chamber 511, the airflow adjustment unit 4 may be controlled to continuously adjust parameters, so as to guarantee that the airflow parameters of the airflow entering the airflow channel are target parameters. Since the airflow channel is narrow and limited in length, the airflow may quickly reach the air outlet end 1121 of the airflow channel after entering the airflow channel, the airflow parameters are not easy to control, and the cleaning effect is affected. The air chamber 511 has enough space for accommodating the airflow, and when the airflow is in the air chamber 511, an input state of the airflow may be adjusted by means of the air supply device 2 and the airflow adjustment unit 4 so as to adjust output parameters of the airflow.

Illustratively, as shown in FIGS. 4 and 5, the mounting portion 5 provided in the present disclosure includes a mounting body 51 and an air inlet pipeline 52, where the air chamber 511 is provided in the mounting body 51. One end of the air inlet pipeline 52 is in communication with the air supply device 2, and the other end of the air inlet pipeline 52 penetrates the mounting body 51, such that the air inlet pipeline 52 may be in communication with the air chamber 511. The mounting body 51 is provided with an opening 512, the opening 512 corresponds to the air inlet end 1111 of the airflow channel, and the air chamber 511 is in communication with the airflow channel by means of the opening 512.

Further, one, two or more air inlet pipelines 52 may be provided. The air inlet pipeline 52 is in communication with the air chamber 511, and the air chamber 511 carries out transfer, such that it is unnecessary to arrange too many air inlet pipelines 52, and the number of the air inlet pipeline 52 is reduced. The air inlet pipeline 52 may be specifically adjusted according to actual needs.

The body structure 1 is of a conical shape, the first face 14 of the body structure 1 is a wider face, and the first face 14 is fixedly connected to the mounting body 51. The second face 15 of the body structure 1 is a narrower face and faces an object 3 to be cleaned. The body structure 1 is of a conical shape and gradually contracts from the wider face to the narrower face, thereby reducing materials and reducing manufacturing cost of the body structure 1. A lower side of the body structure 1 avoids the object 3 to be cleaned, so as to avoid phenomena of mutual interference with the object 3 to be cleaned, collision, etc., and further to protect the object 3 to be cleaned. The air outlet end 1121 of the airflow channel may be exposed out of an upper side of the body structure 1, so as to conveniently check an air outlet state of the air outlet end 1121 of the airflow channel. When blocked, the air outlet end 1121 of the airflow channel may be maintained and cleaned in time, thereby guaranteeing that the air knife may work normally.

The present disclosure further provides a cleaning apparatus. The cleaning apparatus includes an air knife in any embodiment and an object to be cleaned. Airflow in the air knife flows from an air outlet end of the air knife to a surface of the object to be cleaned, so as to clean the object to be cleaned.

As shown in FIGS. 4 and 5, a cleaning apparatus includes an air knife and an object 3 to be cleaned, and airflow in the air knife flows from an air outlet end 1121 of the air knife to a surface of the object 3 to be cleaned.

The object 3 to be cleaned includes a mask 31 and a film 32, the film 32 overlapping the mask 31, and the air outlet end 1121 of the air knife corresponds to the film 32.

A pattern is laid on the mask 31, and the pattern is copied to a wafer by a photoetching technique to form a pattern required by a semiconductor. The mask 31 is prone to be contaminated by particles and other pollutants, and when the pattern of the mask 31 is copied to the wafer, a distorted image is formed on the wafer, which influences the yield of the wafer.

The film 32 is a pellicle, and the film 32 overlaps a surface of the mask 31 for guaranteeing cleanliness of the mask 31 and preventing particles and other pollutants from polluting the mask 31, so as to reduce the influence degree to the minimum.

After the film 32 is connected to the mask 31, the film 32 also needs to be cleaned to keep clean. Under the condition that the film 32 is damaged, the mask 31 is also influenced and damaged. The airflow channel of an embedded structure is used for jetting airflow, the airflow reaches a surface of the film 32, particles and other pollutants on the surface of the film 32 may move under a lateral wind force until the pollutants are separated from the surface of the film 32, thereby achieving the blowing effect. The airflow direction of the air outlet end 1121 of the airflow channel has a preset angle relative to the surface of the film 32, such that a force of the airflow on the surface of the film 32 is moderate, the film 32 is uniformly stressed, the film 32 is prevented from being damaged, and the use safety is improved.

The various embodiments or implementations in the specification are described in a progressive manner, and each embodiment is focused on the differences from other embodiments, and the same and similar parts of the various embodiments are referred to each other.

In the description of this specification, reference terms “an embodiment”, “an illustrative embodiment”, “some implementations”, “an illustrative implementation”, “an example”, etc., mean that a particular feature, structure, material, or characteristic described in conjunction with the embodiment or example is included in at least one embodiment or example of the present disclosure.

In the present specification, schematic expression of the above terms do not necessarily refer to the same embodiment or example. Furthermore, the particular features, structures, materials, or characteristics described may be combined in a suitable manner in any one or more embodiments or examples.

In the description of the present disclosure, it is to be noted that the terms “central”, “upper”, “lower”, “left”, “right”, “vertical”, “horizontal”, “inner”, “outer”, etc. indicate azimuthal or positional relations based on those shown in the drawings only for ease of description of the present disclosure and for simplicity of description, and are not intended to indicate or imply that the referenced device or element must have a particular orientation and be constructed and operative in a particular orientation, and thus may not be construed as a limitation on the present disclosure.

It may be understood that the terms “first”, “second”, etc. as used in the present disclosure may be used to describe various structures in the present disclosure, but these structures are not limited by these terms. These terms are only used to distinguish a first structure from another structure.

In one or more accompanying drawings, the identical elements are denoted by the identical or similar reference numerals. For clarity, many parts in the accompanying drawings are not drawn to scale. In addition, certain well-known parts may not be shown. For brevity, a structure obtained after several steps may be described in one figure. Numerous specific details of the present disclosure are described below, for example, structures, materials, dimensions, processes, and techniques of devices in order to provide a clearer understanding of the present disclosure. However, as will be understood by those skilled in the art, the present disclosure may be practiced without these specific details.

Finally, it should be noted that the above embodiments are merely intended to illustrate the technical solution of the present disclosure and not to limit the same; although the present disclosure has been described in detail with reference to the foregoing embodiments, it should be understood by those skill in the art that the technical solutions described in the foregoing embodiments may be modified or equivalents may be substituted for some or all of the technical features thereof; and the modification or substitution does not make the essence of the corresponding technical solution deviate from the scope of the technical solution of each embodiment of the present disclosure.

### INDUSTRIAL APPLICABILITY

In the air knife and the cleaning apparatus provided in the embodiments of the present disclosure, the through hole in the body structure servers as the airflow channel, and the airflow channel is of an embedded structure, such that the airflow direction of the air outlet end of the airflow channel constantly has a preset angle relative to the object to be cleaned, and damage to the object to be cleaned due to non-uniform stress may be avoided, thereby improving use safety. When airflow flows to the object to be cleaned, particles and other pollutants on the surface of the object to be cleaned move under the influence of the airflow, so as to achieve a cleaning effect.

1. An air knife, comprising a body structure, at least one through hole being provided in the body structure and serving as an airflow channel, an air inlet end of the airflow channel being configured to be in communication with an air supply device, and an airflow direction of an air outlet end of the airflow channel having a preset angle relative to an object to be cleaned.

2. The air knife according to claim 1, wherein the preset angle is 15°-25°.

3. The air knife according to claim 1, wherein the body structure comprises a plurality of airflow channels, and a first plane in which the plurality of airflow channels are located is inclined relative to a second plane in which the object to be cleaned is located, such that the preset angle is formed between the first plane and the second plane.

4. The air knife according to claim 1, wherein the airflow channel is of a cylindrical structure.

5. The air knife according to claim 4, wherein the airflow channel has a preset inner diameter.

6. The air knife according to claim 5, wherein the preset inner diameter is 0.75 mm-1.25 mm.

7. The air knife according to claim 1, further comprising an airflow adjustment unit, the airflow adjustment unit being configured to be connected to the air supply device, so as to adjust an airflow parameter in the airflow channel.

8. The air knife according to claim 7, wherein the airflow adjustment unit comprises a mass flow controller.

9. The air knife according to claim 1, further comprising a mounting portion, the body structure being mounted on the mounting portion, and the mounting portion being configured to be connected to the air supply device; and
an air chamber being provided in the mounting portion, and the air inlet end of the airflow channel being in communication with the air supply device by means of the air chamber.

10. The air knife according to claim 9, wherein the mounting portion comprises a mounting body and at least one air inlet pipeline, and the air chamber is arranged in the mounting body; and
one end of the air inlet pipeline penetrates the mounting body, such that the air inlet pipeline is in communication with the air chamber, and the other end of the air inlet pipeline is in communication with the air supply device.

11. The air knife according to claim 10, wherein the body structure is of a conical shape, a first face of the body structure is configured to be fixedly connected to the mounting body, and a second face of the body structure faces the object to be cleaned.

12. The air knife according to claim 1, wherein the airflow channel has a preset air pressure internally.

13. The air knife according to claim 12, wherein the preset air pressure is greater than 0.3 Mpa.

14. A cleaning apparatus, comprising the air knife according to claim 1 and an object to be cleaned, airflow in the air knife flowing from an air outlet end of the air knife to a surface of the object to be cleaned.

15. The cleaning apparatus according to claim 14, wherein the object to be cleaned comprises a mask and a film, the film overlapping the mask, and the air outlet end of the air knife corresponds to the film.
